(19) United States
(12) Patent Application Publication
(10) Pub. No.: US 2011/0032274 A1
(43) Pub. Date: Feb. 10, 2011

(54) SCREEN DISPLAY SYSTEM AND SCREEN DISPLAY PROGRAM

(75) Inventor: Akira Miyata, Kawasaki (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Kawasaki-shi ,Kanagawa (JP)

(21) Appl. No.: 12/937,437

(22) PCT Filed: Apr. 10, 2008
(86) PCT No.: PCT/JP2008/057071

§ 371 Date: Oct. 12, 2010

(51) Int. Cl. G09G 5/00

(52) U.S. Cl. 345/660

(57) ABSTRACT

A small screen displays system 100 comprises a display device 1 having a large screen 11, a position detecting means (a sensor device 2 and a position detecting unit 4 for detecting sight line positions of users H existing in a detection range S in front of the large screen 11, and a screen processing unit 6 for displaying small screens 7 on the large screen 11 depending on the sight line positions of the users H detected by the position detecting means.

### TECHNICAL FIELD OF THE INVENTION

The present invention relates to a technique of displaying a screen. In particular, the present invention is preferably applied to a screen display system and a screen display program that display a small screen on a large display.

### BACKGROUND ART

In recent years, large displays are provided on the streets or event sites and advertising and presentation images are displayed on the large displays. The large displays are a useful tool to display information for a large audience at the same time. However, it is more useful for individual viewers to be able to operate interactively so that information is displayed on the large displays in response to the operation by each viewer.

A technique related to such an interactive large display system is proposed (see Patent Document 1, for example): for example, on a large display in which a touch panel is installed, a small window is displayed on the large display for each of a plurality of users after a plurality of the users operate the touch panel.

Patent Document 1: Jpn. Pat. Appln. Laid-Open Publication No. 2006-18348

### DISCLOSURE OF THE INVENTION

### Problems to be Solved by the Invention

However, since users need to touch the screen to operate the large display in which the touch panel is installed, some user may feel annoyed at operating the large display. In particular, closing the displayed small windows is more annoying than opening the small windows, Another problem is that when users cannot use their hands, the users cannot operate the large display.

On the other hand, a manager of such a large display system has a problem as well that the manager needs system maintenance personnel for closing small windows because users may leave small windows opened.

The present invention has been made in view of the above circumstances. In one example, the object of the present invention is to provide a screen display system and a screen display program that prevent a user from feeling annoyed when a small screen is displayed on the large display and make system maintenance work easy.

### Means for Solving the Problems

To achieve the above object, the invention of claim 1 is a screen display system comprising: a display means having an image display surface of a first size; a position detection means for detecting a line-of-sight position of a user who exists in a predetermined area in front of the image display surface; and a screen processing means for displaying on the image display surface a small screen of a second size that is smaller than the first size in accordance with the line-of-sight position of the user detected by the position detection means.

Moreover, the invention of claim 14 is a screen display program that can be read by a computer that displays information on a display means having an image display surface of a first size, the screen display program causing the computer to execute: a position detection step of detecting a line-of-sight position of a user who exists in a predetermined area in front of the image display surface; and a screen processing step of displaying on the image display surface a small screen of a second size that is smaller than the first size in accordance with the line-of-sight position of the user detected by the position detection step.

### BRIEF DESCRIPTION OF THE DRAWINGS

FIG. 1 is a diagram illustrating the overall configuration of a small screen display system according to an embodiment of the present invention;

FIG. 2 is a functional configuration diagram of the small screen display system according to the embodiment of the present invention;

FIG. 3 is a diagram illustrating the overall configuration of a sensor device of the small screen display system according to the embodiment of the present invention;

FIG. 4 is a flowchart illustrating the flow of an area detection process of the small screen display system according to the embodiment of the present invention;

FIG. 5 is a flowchart illustrating the flow of an area detection process of the small screen display system according to the embodiment of the present invention;

FIG. 6 is a flowchart illustrating the flow of a screen display process of the small screen display system according to the embodiment of the present invention;

FIG. 7 is a flowchart illustrating the flow of a screen deletion process of the small screen display system according to the embodiment of the present invention;

FIG. 8 is a diagram illustrating how to control displaying of small screens when two users watching different small screens come closer in the small screen display system according to the embodiment of the present invention.;

FIG. 9 is a diagram illustrating how to control displaying of small screens when another user approaches a user watching a small screen in the small screen display system according to the embodiment of the present invention;

FIG. 10 is a diagram illustrating how to control displaying of small screens when a plurality of users simultaneously approach a large screen in the small screen display system according to the embodiment of the present invention; and

FIG. 11 is a diagram illustrating how to control displaying of small screens when one of a plurality of users watching one small screen leaves in the small screen display system according to the embodiment of the present invention.

### DESCRIPTION OF SYMBOLS

1: Display device

2: Sensor device

3: Display control device

4: Position detection device

5: Storage device

6: Screen processing device

7: Small screen

10: Position detection section

20: Storage section

30: Screen processing section

100: Small screen display system

H: User

S: Detection area

P10: Area detection process

P20: Exact position detection process

P30: Screen display process

P40: Screen deletion process

### BEST MODES FOR CARRYING OUT THE INVENTION

Hereinafter, an embodiment of the present invention will be described with reference to the accompanying drawings.

### <Configuration>

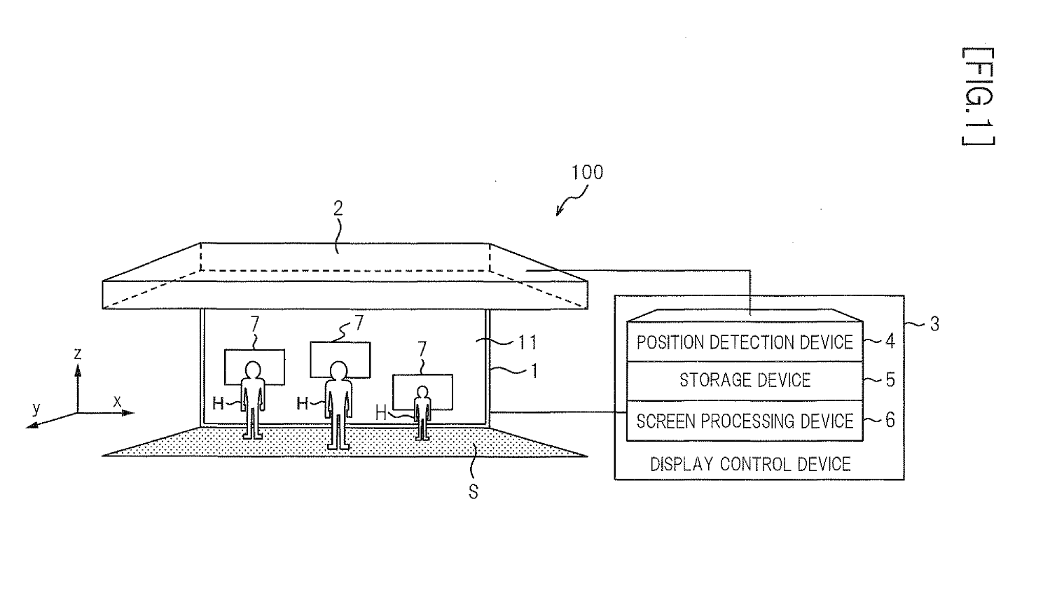

FIG. 1 is a diagram illustrating the overall configuration of a small screen display system (simply referred to as a small screen display system, hereinafter) that uses a large display according to an embodiment of the present invention. The small screen display system 100 includes a display device 1 having a large screen 11 whose size is, for example, larger than 100 inches; a sensor device 2 that detects users H in a detection area S in front of the large screen 11; and a display control device 3 that generates and displays small screens 7 for individual users H on the large screen 11 of the display device 1 in response to how the sensor device 2 detects users. The small screen display system 100 is designed to display the small screens 7 in the most appropriate manner at the most appropriate positions depending on the lines of sight of the users H. Incidentally, according to the present embodiment, the following description uses the coordinate axes illustrated in FIG. 1: an x-axis set in the horizontal direction of the rectangular large screen 11, a z-axis set in the vertical direction (with the large screen 11 on an xy plane), and a y-axis set in the direction perpendicular to the large screen 11.

The display control device 3 includes a position detection device 4 that connects to the sensor device 2 and detects positions of the users H; a storage device 5 that stores various kinds of information to display the small screens 7; and a screen processing device 6 that connects to the display device 1, displays the small screens 7 on the large screen 11 and deletes the small screens 7 displayed on the large screen 11, in response to how the position detection device 4 detects the positions. Incidentally, as for how the display control device 3 is formed, the display control device 3 may be physically one device or have a system structure in which a plurality of devices are connected via a network.

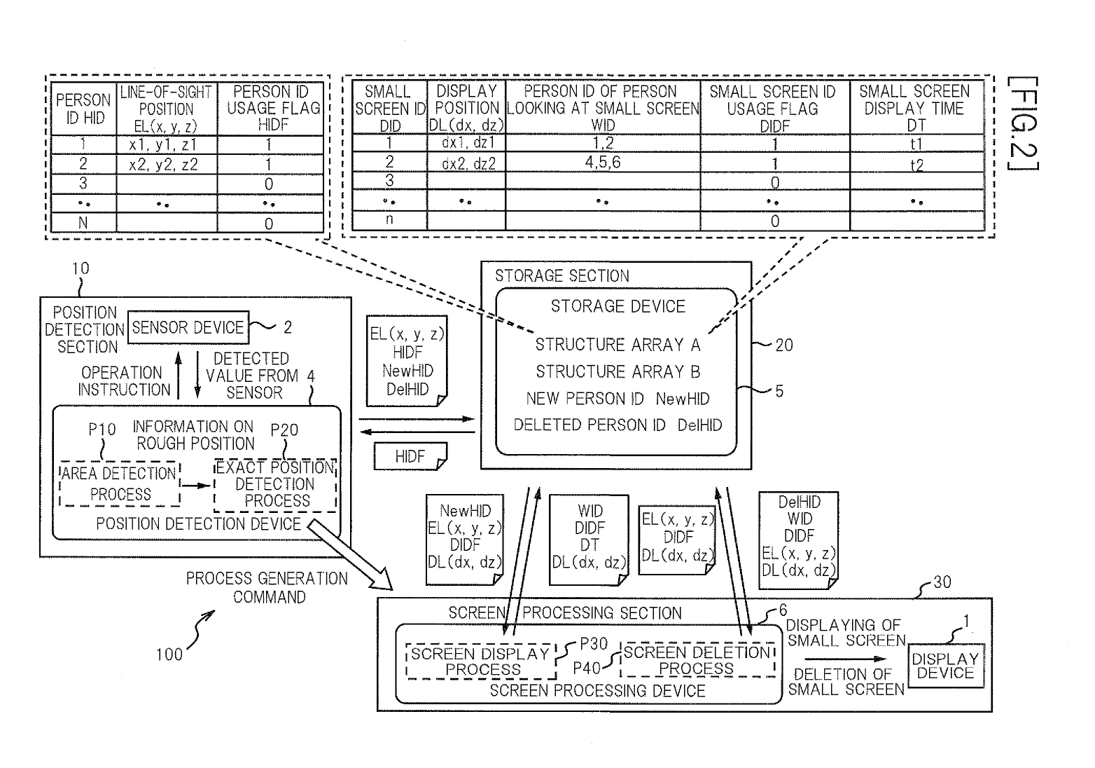

FIG. 2 is a functional configuration diagram of the small screen display system 100 illustrated in FIG. 1. In terms of function, the major components the small screen display system 100 has are a position detection section 10, a storage section 20, and a screen processing section 30.

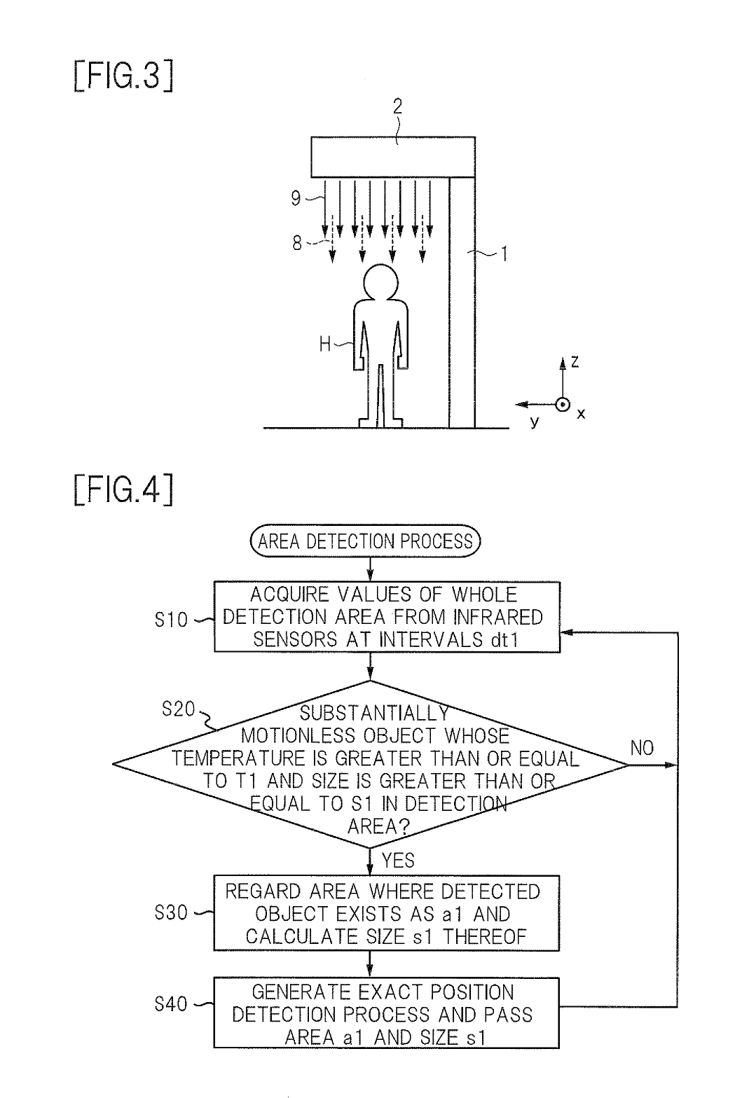

The position detection section 10 includes the sensor device 2 and the position detection device 4. The sensor device 2 can be anything as long as the sensor device 2 is a sensor device of a non-contact type that can detect whether the users H are in the detection area S as well as three-dimensional positions of the users H in the detection area S. According to the present embodiment, as shown in FIGS. 1 and 3, as the sensor devices 2, infrared sensors 8 and ultrasonic sensors 9 are installed in the ceiling above the detection area S to monitor the users H in the detection area S. That is, the infrared sensors 8 and the ultrasonic sensors 9 are equally spaced in a grid pattern right above the detection area S and emit infrared rays and ultrasonic waves in a downward direction to sense objects in the detection area S. According to the present embodiment, the infrared sensors 8 detect a two-dimensional position (xy coordinates) of the detected object (user H); the ultrasonic sensors 9 detect a three-dimensional position (xyz coordinates) of the detected object (user H). Incidentally, according to the present embodiment, the infrared sensors 8 are used to roughly detect the position of the object. Therefore, the infrared sensors 8 may be less densely disposed than the ultrasonic sensors 9.

The position detection device 4 uses information detected by the sensor device 2 to perform a position detection process. The position detection process of the present embodiment mainly consists of an area detection process P10 and an exact position detection process P20. The area detection process P10 makes the infrared sensors 8 operate and roughly detects an area where an object exists on the basis of information acquired by the infrared sensors 8. Meanwhile, the exact position detection process P20 makes the ultrasonic sensors 9 operate in response to the result of the area detection process P10; makes a determination as to whether the object detected by the area detection process P10 is a person on the basis of information acquired by the ultrasonic sensors 9; and calculates a position of the user H's line of sight if the object is a person.

The storage section 20 consists of the storage device 5 and stores various kinds of information to display the small screens 7. More specifically, the storage section 20 stores such information as: a structure array A for managing the line-of-sight positions of the users H in the detection area S; a structure array B for managing the display positions of the small screens 7 displayed and the users H who look at the small screens 7; new person IDs for managing persons who start viewing; and deleted person IDs for managing persons who stop viewing.

The structure array A manages information about the users H and is a structure array whose constituent elements include: person IDs (represented by HIDs) that enable the users H to be uniquely identified; the line-of-sight positions of the users H (represented by three-dimensional coordinates, or EL (x, y, z)); and person ID usage flags (represented by HIDFs) indicating whether an data item of the sequence number is used. According to the present embodiment, the HIDs are used as sequence numbers for the structure array A. The HIDF is set at 1 when the data item of the sequence number is used and at 0 when the data item is not used.

The structure array B manages information about the small screens 7 to be displayed and is a structure array whose constituent elements include: small screen IDs (represented by DIDs) that enable the small screens 7 to be uniquely identified; the display positions of the small screens 7 (represented by two-dimensional coordinates, or DL(dx, dz)); person IDs (represented by WIDs) of persons who look at the small screens 7; small screen ID usage flags (represented by DIDFs) indicating whether an data item of the sequence number is used; and the time (represented by DT) at which the small screen 7 starts to be displayed. According to the present embodiment, the DIDs are used as sequence numbers for the structure array B. The DIDF is set at 1 when the data item of the sequence number is used and at 0 when the data item is not used.

The new person IDs are information that is recorded in the process by the position detection section 10 after the user H who starts viewing is detected; the person ID (HID) of the user H is set as a new person ID (represented by NewHID).

The deleted person IDs are information that is recorded in the process by the position detection section 10 after the user H who stops viewing is detected; the person ID (HID) of the user H is set as a deleted person ID (represented by DelHID).

The screen processing section 30 consists of the screen processing device 6 and the display device 1. Depending on a position detection state of the position detection section 10, the screen processing device 6 performs a screen display process P30 to display the small screen 7 on the large screen 11 of the display device 1 and a screen deletion process P40 to delete the small screen 7 displayed on the large screen 11 of the display device 1.

The screen display process P30 displays the small screen 7 at the line-of-sight position of the detected user H after the user H who newly starts viewing is detected in the process by the position detection section 10. However, if there is already the small screen 7 displayed nearby, or if a plurality of the users H turn up almost at the same time, the screen display process P30 does not display a new small screen 7, or alternatively the screen display process 30 displays the already displayed small screen 7 again at a suitable position for a plurality of the users H. Such a display control task of the screen display process P30 will be de described below in detail.

The screen deletion process P40 deletes the small screen 7 the user H has been viewing after the user H who stops viewing is detected in the process by the position detection section 10. However, if there is another user H viewing the same small screen 7 as the user H does, the screen deletion process P40 does not delete the small screen 7 and then displays the small screen 7 again at a suitable position for the another user H. Such a display control task of the screen deletion process P40 will be de described below in detail.

More specifically, the small screen display system 100 includes a central processing unit (CPU) equipped with at least calculation and control functions; and a main storage device (memory) consisting of a ROM, a RAM, and the like, and an auxiliary storage device such as hard disks, equipped with a storage function to store programs and data. Among the above components, the position detection section 10 and the screen processing section 30 specifically represent the calculation and control functions of the small screen display system 100, and the storage section 20 specifically represents the storage function of the small screen display system 100.

The programs to execute various processes of the present embodiment (which are specifically the area detection process P10, the exact position detection process P20, the screen display process P30 and the screen deletion process P40) are stored in the above main storage device or hard disk. However, the programs may be stored in portable flash memories, CD-ROM, MO, DVD-ROM and other AV devices and in computer-readable recording media. The programs may be delivered via a communication network.

### <Operation>

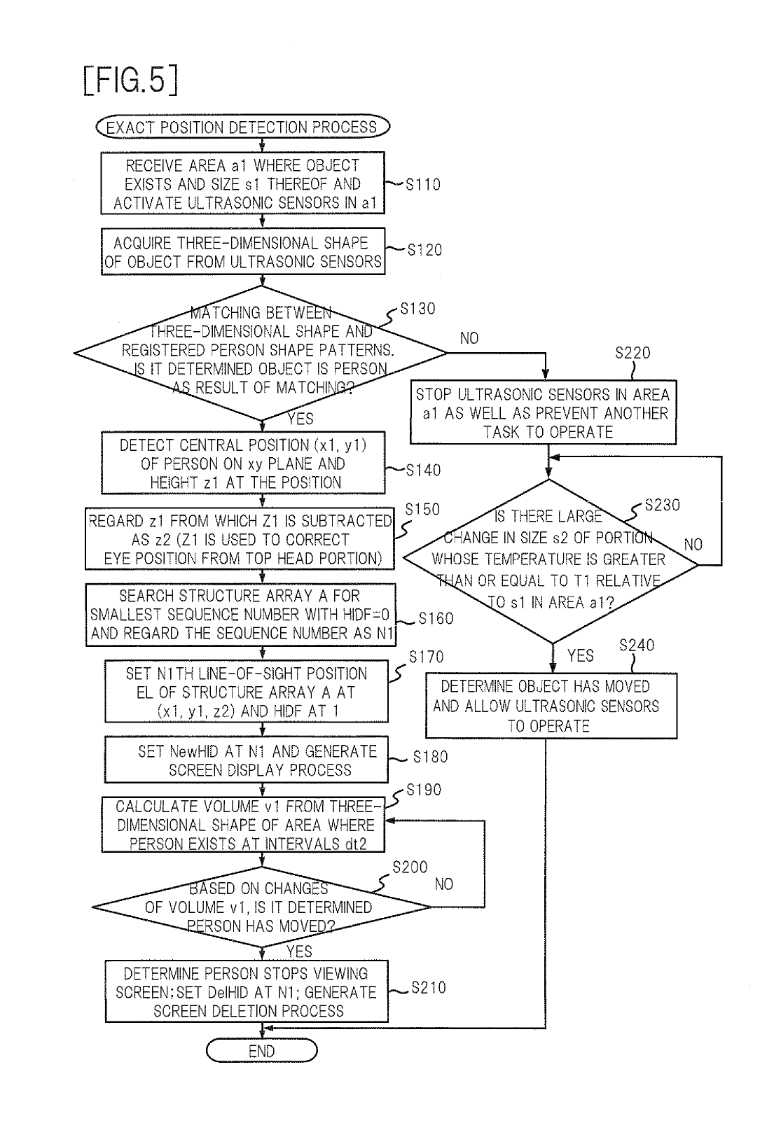

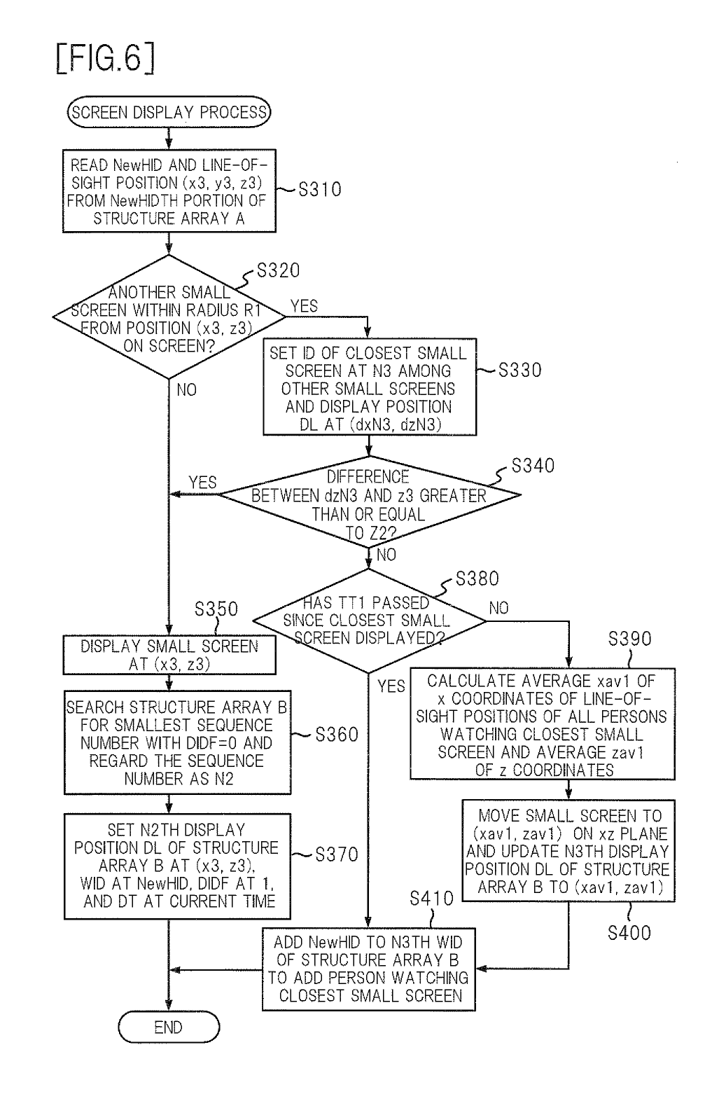

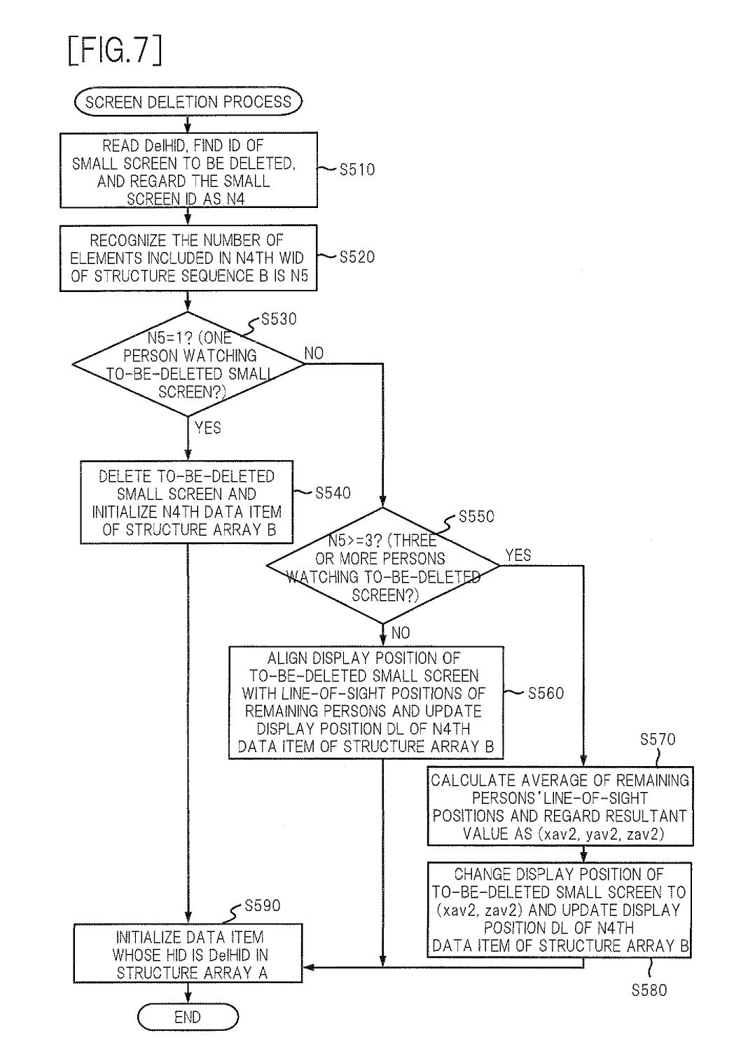

The following describes the operation of the small screen display system 100 according to the embodiment of the present invention with reference to FIGS. 4 to 7. FIG. 4 is a flowchart illustrating the flow of the area detection process P10 performed by the position detection section 10 of the small screen display system 100. FIG. 5 is a flowchart illustrating the flow of the exact position detection process P20 performed by the position detection section 10 of the small screen display system 100. FIG. 6 is a flowchart illustrating the flow of the screen display process P30 performed by the screen processing section 30 of the small screen display system 100. FIG. 7 is a flowchart illustrating the flow of the screen deletion process P40 performed by the screen processing section 30 of the small screen display system 100.

### (Area Detection Process)

As described above, the area detection process P10 roughly detects the position where an object exists and is continuously running in the position detection section 10.

First, the position detection device 4 acquires the values of the whole detection area S from the infrared sensors 8 at intervals of dt1 (step S10).

Based on the acquired values, the position detection device 4 then makes a determination as to whether there is an object looking at the large screen 11 (step S20). More specifically, the position detection device 4 makes a determination as to whether an object whose temperature is greater than or equal to a temperature of T1 (which is set closer to human body temperatures) and whose size is greater than or equal to a size of S1 (which is set closer to an area occupied by a person) is detected on the basis of the values acquired from the infrared sensors 8 and whether the motion of the object is very little (which is specifically determined by changes in the position of the object detected at intervals of dt1). That is, according to the present embodiment, it is determined that the object is looking at the large screen 11 when the object whose temperature is greater than or equal to the temperature T1 and whose size is greater than or equal to the size S1 is detected and when the movement of the object is very little.

When it is determined that there is the object looking at the large screen 11 (step S20: YES), the position detection device 4 calculates the size s1 of an area a1 occupied by the object (step S30), generates the exact position detection process P20, passes the area a1 and the size s1 as arguments (step S40), and returns to step S10. On the other hand, when it is determined that there is no object looking at the large screen 11 (step S20: NO), the position detection device 4 returns to step S10.

Incidentally, if a plurality of objects looking at the large screen 11 are detected at the same time at step S20, the position detection device 4 generates a plurality of the exact position detection processes P20 in accordance with individual objects and makes the processes run in parallel. Moreover, at step S20, in the area detection process P10, the infrared sensors 8 are stopped in the area a1 after the object looking at the large screen 11 is detected in order to prevent the same object from being detected again.

### (Exact Detection Process)

As described above, the exact position detection process P20 makes a determination as to whether the object detected by the area detection process P10 is a person. When the object is a person, the exact position detection process P20 calculates the line-of-sight position of the person. The exact position detection process P20 is initiated by instructions from the area detection process P10.

After receiving the area a1 and the size s1 from the area detection process P10 (see step S40), the position detection device 4 starts running the ultrasonic sensors 9 in the area a1 (step S110), acquires values for the area a1 from the ultrasonic sensors 9, and detects the three-dimensional shape of the object (step S120).

Subsequently, the position detection device 4 performs matching by comparing the three-dimensional shape of the detected object with person shape patterns that are registered in advance to make a determination as to whether the three-dimensional shape of the detected object is in the shape of a human being (step S130); the determination process is intended to avoid malfunctions associated with any objects other than human beings (animals and the like, for example). The person shape patterns, for example, include a plurality of expected patterns about human posture, such as a standing person, a slouching person and a person sitting on the ground; a plurality of the patterns about human posture are registered in advance in the position detection device 4. Since a plurality of the patterns about human posture are stored as described above, it is possible to detect people with various body shapes and in various postures such as a person standing straight and an aged person whose back is bent. Incidentally, exception patterns (posture patterns of animals such as dogs and cats, for example) may be registered in advance with an additional function of determining whether the three-dimensional shape matches an exception pattern; if the three-dimensional shape matches an exception pattern, it may be determined that the three-dimensional shape of the detected object is not in the human shape. In this case, it is possible to further reduce malfunctions associated with any objects other than human beings.

When it is determined that the object is a person on the basis of the three-dimensional shape of the detected object (step S130: YES), the position detection device 4 detects central position (x1, y1) of the user H on the xy plane and the height z1 of the user H (S140), and then calculates the height z2 of eyes from the height z1 of the user H (step S150). Since the height z1 of the user H is a measure of the height of the top of the head, z1 needs to be corrected to calculate the line-of-sight position of the eyes. According to the present embodiment, suppose that the eyes are positioned substantially at the midpoint of the length of the head. The length of the head is calculated from the difference between the height of the top of the head of the person detected from the three-dimensional shape and the height of the shoulder. The length of the head is divided by two and the resultant value Z1 is subtracted to calculate the height z2 of the eyes (if the length of the head is about 20 cm, Z1 is around 10 cm). Incidentally, in order to more accurately calculate the height of eyes, a correction value table may be produced according to the height of the top of the head and used to calculate the height of the eyes.

The position detection device 4 then makes reference to the structure array A of the storage device 5 and acquires the data item that is not used (HIDF=0) and has the smallest sequence number (step S160), sets line-of-sight position EL (x, y, z) of the data item at line-of-sight coordinate (x1, y1, z2) of the calculated user H, and sets the HIDF at 1 for updating (step S170). For example, in the structure array A, if the data item of the sequence number N1 is not used and if the sequence number N1 is the smallest among the unused data items, the line-of-sight position EL of the N1th data item of the structure array A is set at (x1, y1, z2), the HIDF is set at 1, and the data item is updated.

Moreover, the position detection device 4 sets the new person ID (NewHID) of the storage device 5 at the HID (sequence number) of the user H (step S170), and instructs the screen processing device 6 to generate the screen display process P30 (step S180). For example, If the line-of-sight position EL is updated for the N1th data item of the structure array A, the NewHID is set at N1 and recorded in the storage device 5. As a result, in the screen display process P30 described below, it is possible for the screen processing device 6 to figure out to which person a new small screen 7 should be displayed. Incidentally, since an initialization process takes place when the new person ID is recorded in the storage device 5, the elements corresponding to the new person ID, recorded until that moment are cleared.

The position detection device 4 then calculates the volume v1 of a space occupied by the user H at intervals of dt2 on the basis of the three-dimensional shape of the user H (step S190); the process is intended to monitor whether the user H goes away from (or stay in front of) the large screen 11 (or the small screen 7) after detecting the position of the user H.

The position detection device 4 makes a determination as to whether the person has moved based on a change in the calculated volume v1 (step S200). More specifically, when the change of the volume v1 is large, i.e. the rate of decrease of the volume v1 is larger than a predetermined threshold, it is determined that the person has departed from a viewing position. When the change of the volume v1 is not large, it is determined that the person stays at the viewing position watching the small screen 7.

When it is determined from the change of the volume vi that the user H has moved (step S200: YES), the position detection device 4 determines that the user H stops watching the small screen 7, sets the deleted person ID (DelHID) of the storage device 5 at the HID of the user H, instructs the screen processing device 6 to generate the screen deletion process P40 (step S210), and ends the process. For example, when the HID (sequence number) of the user H is N1, the DelHID is set at N1 and recorded in the storage device 5. As a result, in the screen deletion process P40 described below, the screen processing device 6 can figure out which small screen 7 to delete. Incidentally, since the initialization process takes place when the deleted person ID of the storage device 5 is recorded, the elements corresponding to the deleted person ID, recorded until that moment are cleared. When it is determined from the change of the volume v1 that the user H has not moved (step S200: NO), the position detection device 4 repeats the process of step S190.

On the other hand, when it is determined from the three-dimensional shape of the detected object that the object is not a person (step S130: NO), the position detection device 4 stops the operation of the ultrasonic sensors 9 running in the area a1 (step S220). Moreover, as for the area a1, the ultrasonic sensors 9 are locked so another exact position detection process P30 is not allowed to run the ultrasonic sensors 9 with the aim of preventing any objects other than human beings from being detected repeatedly.

Subsequently, the position detection device 4 makes a determination as to whether the detected object has moved (step S230). More specifically, when the size s2 of a portion whose temperature is greater than or equal to T1 has changed significantly from the initial size s1 in the area a1, for example when the size s2 becomes significantly smaller than the size s1, it is determined that the detected object has moved.

When the detected object has moved (step S230: YES), the position detection device 4 unlocks the ultrasonic sensors 9 to allow the operation of the ultrasonic sensors 9 in the area a1 (step S240) before ending the process with the aim of enabling other objects to be detected because other objects might come to the above position. On the other hand, when the detected object has not moved (step S230: NO), the position detection device 4 repeats the process of step S230.

### (Screen Display Process)

As described above, the screen display process P30 displays the small screen 7 at the line-of-sight position of a new user H detected by the position detection section 10. The screen display process P30 is initiated by instructions from the exact position detection process P20.

First the screen processing device 6 reads out the new person ID (NewHID) recorded in the storage device 5 and acquires the line-of-sight position EL of the corresponding data item from the structure array A on the basis of the new person ID the screen processing device 6 has read out (step S310). For example, suppose that the NewHID is N1 and the line-of-sight position EL of the N1th data item of the structure array A is (x3, y3, z3).

The screen processing device 6 then makes a determination as to whether there is another small screen 7 near the position (x3, z3) where a small screen 7 should be displayed (step S320). The determination is made to keep a small screen 7 from being displayed when a small screen 7 has been displayed near (x3, z3) because displaying another new small screen 7 near the small screen 7 is rather intrusive and not appropriate. More specifically, the screen processing device 6 makes reference to the display position DL of the structure array B to make a determination as to whether another small screen 7 exists within a predetermined radius of R1 from the position (x3, z3).

When there is no small screen 7 near the position (x3, z3) where a small screen 7 should be displayed (step S320: NO), the screen processing device 6 displays a small screen 7 at the position (x3, z3) where the small screen 7 should be displayed (step S350). According to the present embodiment, the screen processing device 6 displays the small screen 7 of size 12 inches or so with the center of the small screen 7 positioned at x3 in terms of the x-axis direction and with the upper side positioned at z3 in terms of the z-axis direction. That is, the user H looks slightly down at the small screen 7.

The screen processing device 6 then makes reference to the structure array B of the storage device 5 and acquires a data item that is not used (DIDF=0) and has the smallest sequence number (step S360); sets the display position DL of the data item at the position (x3, z3) where the small screen 7 is displayed; sets WID, DT and DIDF at the NewID, the current time and 1, respectively; updates the data item (step S370); and ends the process. For example, in the structure array B, if the data item of the sequence number N2 is not used and if the sequence number N2 is the smallest among the unused data items, the display position DL of the N2th data item of the structure array B, the WID, the DT and the DIDF are set at (x3, z3), the NewID, the current time and 1, respectively, and the data item is updated.

On the other hand, when there is another small screen 7 near the position (x3, z3) where a small screen 7 should be displayed (step S320: YES), the screen processing device 6 makes reference to the structure array B to acquire the display position DL (dx, dz) of the small screen 7 at the closest position (referred to as the closest small screen 7, hereinafter) (step S330), compares the z coordinate dz of the closest small screen 7 with z3, and makes a determination as to whether the difference between dz and z3 is greater than or equal to Z2 (step S340). For example, if the DID of the closest small screen 7 is N3 and if the display position DL of the closest small screen 7 is (dxN3, dzN3), a determination is made as to whether the difference between z3 and dzN3 is greater than or equal to Z2. The determination is made to check if the positions are in the following state: the z positions are far apart from each other even if the xy positions are substantially the same or close (which means, for example, that a child tries to watch the small screen 7 that an adult is looking at), in which case different small screens 7 should be displayed according to height.

When the difference between z3 and dzN3 is greater than or equal to Z2 (step S340: YES), i.e. the height difference is greater than or equal to a predetermined threshold of Z2, the screen processing device 6 performs the above processes of step S350 to S370 in order to display a new small screen 7. As a result, the user H, a newcomer, is able to watch the new small screen 7 being displayed.

On the other hand, when the difference between z3 and dzN3 is less than Z2 (step S340: NO), the screen processing device 6 makes a determination as to whether a predetermined period of time TT1 or more has passed since the closest small screen 7 is displayed (step S380). When small screens 7 are displayed for a plurality of users H who substantially simultaneously appear in the detection area 5, making the above determination helps prevent the small screens 7 from being displayed according to the line of sight of the user H who is the first person detected among a plurality of the users. According to the present embodiment, TT1 is set at several seconds or so. Incidentally, the time that has lapsed since the closest small screen 7 is displayed is calculated from DT and the current time.

When the predetermined period of time TT1 has passed since the closest small screen 7 is displayed (step S380: YES), the screen processing device 6 does not make a position correction of the closest small screen 7. Instead the screen processing device 6 acquires the data item having the DID of the closest small screen 7 from the structure array B, adds the NewHID to the WID of the data item, and updates the data item (step S410). For example, when the DID of the closest small screen 7 is N3, the NewHID is added to the WID of the N3th data item of the structure array B and the data item is updated.

In that manner, if another user H comes closer to the closest small screen 7 after a long period of time has passed since the closest small screen 7 is displayed, the screen processing device 6 does not change the position of the closest small screen 7 displayed for the previous user H and continues to display at the same position.

On the other hand, when the predetermined period of time TT1 has not passed since the closest small screen 7 is displayed (step S380: NO), the screen processing device 6 acquires the data item having the DID of the closest small screen 7 from the structure array B; makes reference to the person IDs of all persons who are watching the closest small screen 7 on the basis of the WID of the data item; makes reference to the structure array A on the basis of the person IDs that the screen processing device 6 has made reference to; and calculates the average of x and z coordinates of the line-of-sight positions EL of all the persons who are watching the closest small screen 7 (step S390). Here, suppose that the average of x coordinates of the line-of-sight positions EL of all the persons who are watching the closest small screen 7 is xav1, and the average of z coordinates zav1.

Then, the screen processing device 6 displays a small screen 7 at (xav1, zav1); acquires the data item having the DID of the closest small screen 7 from the structure array B; sets the display position DL of the data item at (xav1, zav1) (step S400); adds the NewHID to the WID; and updates the data item (step S410). For example, when the DID of the closest small screen 7 is N3, the display position DL of the N3th data item of the structure array B is set at (xav1, zav1), the NewHID is added to the WID, and the data item is updated.

In that manner, when another user H comes closer to the closest small screen 7 before much time has passed since the closest small screen 7 is displayed (which means that a plurality of users H substantially simultaneously come closer to the large screen 11), the screen processing device 6 calculates the average position of the lines of sight of a plurality of the users H and moves the closest small screen 7 to the calculated average position to display.

### (Screen Deletion Process)

As described above, the screen deletion process P40 deletes the small screen 7 the user H has been looking at when the user stops watching the small screen 7. The screen deletion process P40 is initiated by instructions from the exact position detection process P20.

First the screen processing device 6 reads out the deleted person ID (DelHID) recorded in the storage device 5, makes reference to the WID of the structure array B on the basis of the deleted person ID that the screen processing device 6 has read out, and acquires the corresponding data item (step S510). For example, suppose that the DelHID is N1 and in the structure array B, the DID of the data item whose WID includes N1 is N4.

The screen processing device 6 counts the number of elements included in the WID of the N4th data item of the structure array B, i.e. the number of person IDs included in the WID (step S520). Here, suppose that the number of person IDs included in the WID is N5.

Subsequently, the screen processing device 6 uses the above value of N5 to make a determination as to whether the number of users H watching the small screen 7 (referred to as a to-be-deleted small screen 7, hereinafter) whose DID is N4 is one (step S530).

When there is only one user H watching the to-be-deleted small screen 7 (step S530: YES), the screen processing device 6 deletes the to-be-deleted small screen 7 and initializes the N4th data item of the structure array B (step S540). The initialization of the data item of the structure array B specifically means that the display position, WID, DIDF and DT of the data item are initialized. Incidentally, the DIDF is set at

The screen processing device 6 then acquires the data item of the structure array A whose HID is the deleted person ID, initializes the data item the screen processing device 6 has acquired (step S590), and ends the process. The initialization of the data item of the structure array A specifically means that the line-of-sight position EL and HIDF of the data item are initialized. Incidentally, the HIDF is set at 0. For example, when the DelHID is N1, the N1th data item of the structure array A is initialized.

When there are two or more users H watching the to-be-deleted small screen 7 (step S530: NO), the screen processing device 6 makes a determination as to whether there are three or more users watching the to-be-deleted small screen 7 (step S550).

When the number of users H watching the to-be-deleted small screen 7 is not three or more, i.e. two (step S550: NO), then one user H (referred to as a remaining user H) is left watching the to-be-deleted small screen 7 continuously. Therefore, the screen processing device 6 moves the display position of the to-be-deleted small screen 7 in accordance with the line-of-sight position of the remaining user H, sets the display position DL of the N4th data item of the structure array B at the line-of-sight position of the remaining user H, and updates the data item (S560). For example, if it is determined from the WID of the N4th data item of the structure array B that the person ID of the remaining user is N5, the screen processing device 6 acquires the line-of-sight position EL of the data item whose HID of the structure array A is N5, the to-be-deleted small screen 7 is displayed at the x and z coordinates of the acquired line-of-sight position EL, and the display position DL of the N4th data item of the structure array B is set at the x and z coordinates of the acquired line-of-sight position EL. Incidentally, after the display position DL of the to-be-deleted small screen 7 is changed and the structure array B is updated, the screen processing device 6 proceeds to the above step S590; the screen processing device 6 acquires the data item of the structure array A whose HID is the DelHID, initializes the acquired data item, and ends the process.

On the other hand, when the number of users H watching the to-be-deleted small screen 7 is three or more (step S550: YES), then two or more users H are left watching the to-be-deleted small screen 7 continuously. The screen processing device 6 therefore calculates the average of the line-of-sight positions of the remaining users H (step S570). For example, if it is determined from the WID of the N4th data item of the structure array B that the person IDs of the remaining users are N5 and N6, the screen processing device 6 acquires the line-of-sight positions EL of the data items whose HIDs of the structure array A are N5 and N6, and the average of the acquired line-of-sight positions is calculated. Here, suppose that the average of x coordinates of the line-of-sight positions EL of the remaining users H is xav2, the average of y coordinates yav2, and the average of z coordinates zav2.

Subsequently, the screen processing device 6 displays the to-be-deleted small screen 7 at (xav2, zav2), sets the display position DL of the N4th data item of the structure array B at (xav2, zav2), and updates the data item (step S580). Incidentally, after the display position DL of the to-be-deleted small screen 7 is changed and the structure array B is updated, the screen processing device 6 proceeds to the above step S590; the screen processing device 6 acquires the data item of the structure array A whose HID is the DelHID, initializes the acquired data item, and ends the process.

### <Specific Examples of Small Screen Display Control>

The following describes in detail how to control the displaying of small screens in the above small screen display system 100 in comparison with the behavior of the users H.

### (Two Users H Watching Different Small Screens 7 Come Closer to Each Other)

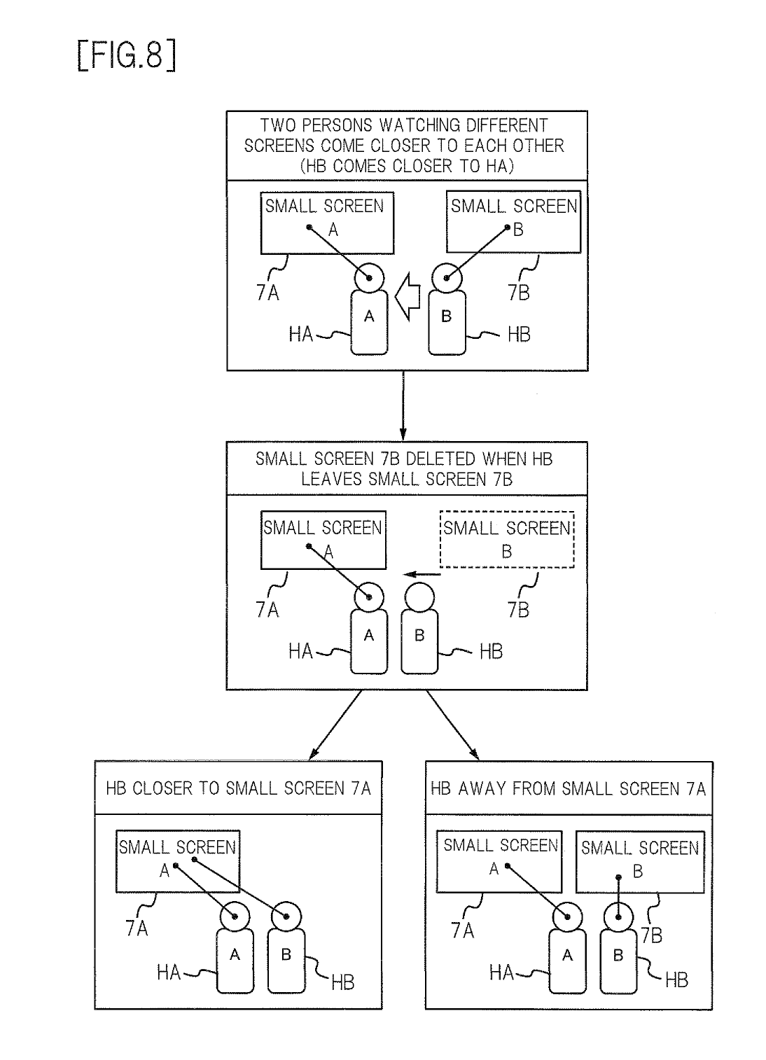

Described with reference to FIG. 8 is the case in which after a user HA and a user HB are watching a small screen 7A and a small screen 7B, respectively, the user HB comes closer to the user HA.

After the user HB goes away from the small screen 7B, the small screen display system 100 deletes the small screen 7B that the user HB has been watching (see steps S200 and 5210 of the exact position detection process and steps S530 (NO) and 5540 of the screen deletion process).

When the user HB is then coming closer to the user HA and the small screen 7A, the small screen display system 100 does not display a new small screen 7 and does not change the display position of the small screen 7A (see steps S320 (YES), S340 (NO), S380 (YES) and S410 of the screen display process). Accordingly, the user HB watches the small screen 7A that remains unchanged in position.

On the other hand, when the user HB comes closer to the user HA but stays away from the small screen 7A, the small screen display system 100 displays a new small screen 7B in the line of sight of the user HB (see steps S320 (NO) and S350 of the screen display process). As a result, the user HB watches the new small screen 7B.

### (Another User H Comes Closer to User H Watching Small Screen 7)

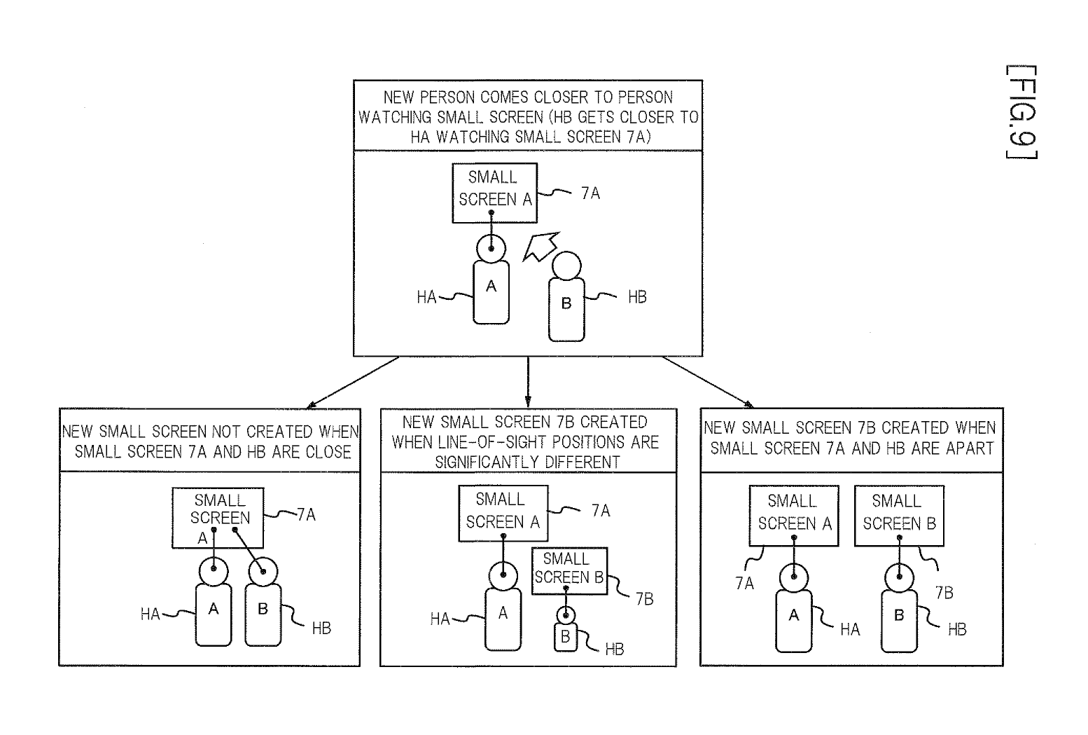

Described with reference to FIG. 9 is the case in which when the user HA is watching the small screen 7A, another user HB gets closer.

When the user HB gets closer to the user HA and the small screen 7A, the small screen display system 100 does not display a new small screen 7 and does not change the display position of the small screen 7A (see steps S320 (YES), S340 (NO), S380 (YES) and S410 of the screen display process). Accordingly, the user HB watches the small screen 7A that remains unchanged in position.

On the other hand, when the user HB comes closer to the usr HA and the small screen 7A but the height of the line-of-sight position of the user HB is significantly different from the height of the line-of-sight position of the user HA, the small screen display system 100 displays a new small screen 7B in the line of sight of the user HB (see steps S320 (YES) and 5340 (YES) and 5350 of the screen display process).

When the user HB comes closer to the user HA but stays away from the small screen 7A, the small screen display system 100 displays a new small screen 7B in the line of sight of the user HB (see steps S320 (NO) and S350 of the screen display process). As a result, the user HB watches the new small screen 7B.

### (Plurality of Users H Simultaneously Comes to Watch Small Screen 7)

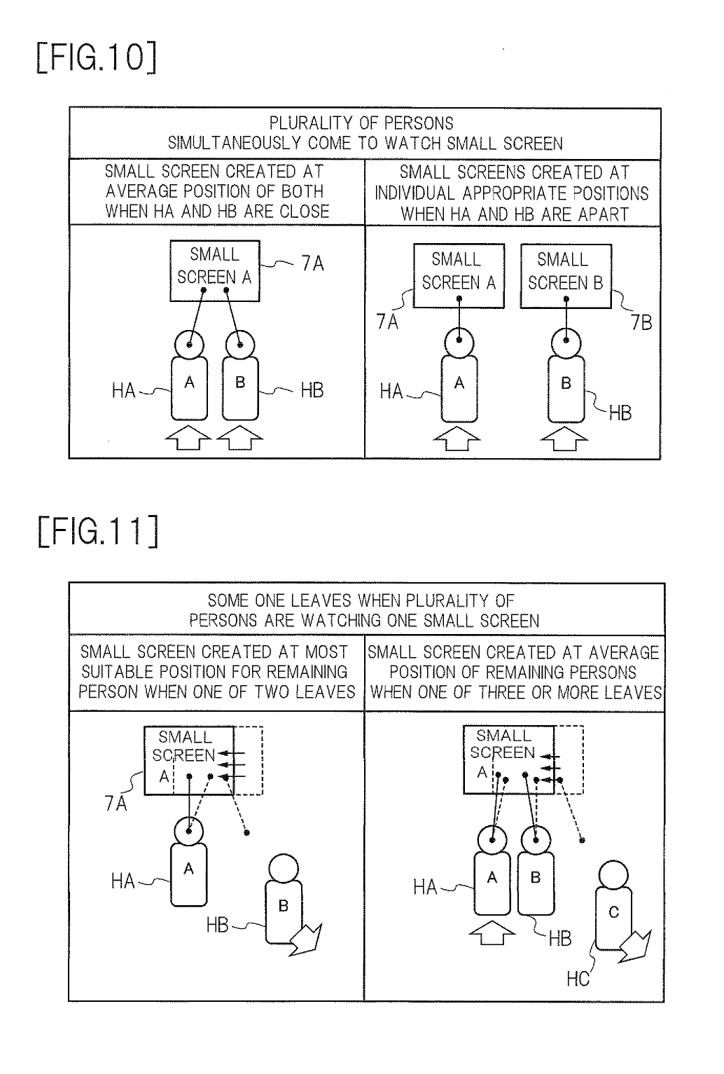

Described with reference to FIG. 10 is the case in which the user HA and the user HB substantially simultaneously enter the detection area S to watch the small screen 7.

When the user HA and the user HB are close, the small screen display system 100 displays a small screen 7A at the average line-of-sight position of both users (which is the average of the x and z coordinates of the line-of-sight positions) (see steps S320 (YES), S340 (NO), S380 (NO), S390 and S400 of the screen display process). Accordingly, the users HA and HB watch the small screen 7A displayed at the midpoint between the two persons.

On the other hand, when the user HA and the user HB are apart, the small screen display system 100 displays a new small screen 7A in the line of sight of the user HA and a new small screen 7B in the line of sight of the user HB (see steps S320 (NO) and 5350 of the screen display process). As a result, the user HA watches the small screen 7A and the user HB the small screen 7B.

### (With Plurality of Users H Watching One Small Screen 7, One User H Leaves)

Described first with reference to FIG. 11 is the case in which when the user HA and the user HB are watching the small screen 7A, the user HB leaves. In this case, only the user HA continues to watch the small screen 7A. Therefore, the small screen display system 100 moves the small screen 7A to the line-of-sight position of the user HA for display (steps S530 (NO), S550 (NO) and S560 of the screen deletion process). As a result, the user HA watches the small screen 7A displayed at the line-of-sight position of the user HA.

The following describes the case in which when the user HA, the user HB, and the user HC are watching the small screen 7A, the user HC leaves. In this case, the users HA and HB continue to watch the small screen 7A. Therefore, the small screen display system 100 moves the small screen 7A to the average line-of-sight position of the users HA and HB (which is the average of x and y coordinates) for display (see steps S530 (NO), S550 (YES), S570 and S580 of the screen deletion process). As a result, the users HA and HB watch the small screen 7A displayed at the midpoint between the two persons.

As described above, according to the present embodiment, the small screen display system 100 includes the display device 1 having the large screen 11; the position detection section 10 that detects the line-of-sight position of a user H within the detection area S in front of the large screen 11; and the screen processing device 6 that displays the small screen 7 in accordance with the line-of-sight position of the user H detected by the position detection section 10 on the large screen 11. Therefore, the user H does not feel annoyed at operation when the small screen 7 is displayed on the large display. That is, in the small screen display system 100 of the present embodiment, the sensor device 2 of the position detection section 10 serves as a non-contact sensor, allowing the user H not to perform display operations. Since the position detection device 4 automatically detects the line-of-sight position of the user H and the screen processing device 6 displays the small screen in accordance with the line-of-sight position of the user H, the user H does not feel annoyed at display operations. Moreover, in the small screen display system 100 of the present embodiment, even if the user H does not perform deletion operations, the position detection device 4 automatically detects the motion of the user H and the screen processing device 6 deletes the displayed small screen 7. Therefore, the user H does not feel annoyed at deletion operations. Moreover, system maintenance personnel is not required for deleting the small screen 7, making it easy to maintain the system.

Moreover, according to the present embodiment, the small screen display system 100 has a display control algorithm to display the small screens 7 at the most suitable positions according to how a plurality of users H gathers. Therefore, even if there is a plurality of users H at the same time in front of the large screen 11, the small screens 7 are displayed at the most suitable positions for individual users H. For example, when a plurality of users H are apart, the small screens 7 are displayed at appropriate positions in accordance with the line-of-sight positions of the individual users H. When a plurality of users H is close, a common small screen 7 is displayed at the average position of the line-of-sight positions of the individual users H or is so displayed as to stay at the display position of the small screen 7 of the user H who is the first person to begin to watch. Therefore, even when a plurality of users H is close, the small screens 7 are displayed without annoying the individual users H. Even when the lines of sight of a plurality of users H who are close to each other are significantly different in height, the small screens 7 are displayed for the individual users H. Therefore, it is possible to take into account the heights of the users H when it comes to displaying small screens. Even when one of a plurality of users H who are watching one small screen 7 leaves, it is possible to move the displayed screen 7 to the most appropriate line-of-sight position in accordance with the number of the remaining users H. For example, when only one user H remains, the small screen 7 is displayed in accordance with the line-of-sight position of the remaining user H. When two or more users H remain, the small screen 7 is displayed at the average position of the line-of-sight positions of the remaining users H. Therefore, the small screen 7 is displayed at a suitable position for remaining users H.

Moreover, according to the present embodiment, after it is determined that the object is a person, the small screen display system 100 detects the line-of-sight position of the user H. Therefore, it is possible to avoid malfunctions associated with unnecessary objects.

According to the small screen display system 100 of the present embodiment, the size of the small screen 7 is about 12 inches. However, the size of the small screen 7 is not limited to the above. Moreover, according to the small screen display system 100 of the present embodiment, the size of the small screen 7 remains unchanged when being displayed. However, the size of the small screen 7 may vary. For example, the size of the small screen 7 may change according to the distance (y coordinate) from the large screen 11 of the display device 1. In this case, the size of the small screen 7 is so controlled to become larger as a user moves away from the large screen 11. The size of the small screen 7 may be controlled and changed in such a manner only when one user H is watching one small screen 7. When a plurality of users H is looking at one small screen 7, the size of the small screen 7 may be determined based on the average of the y coordinates of a plurality of the users H.

Moreover, according to the present embodiment, the small screen display system 100 uses the sensor devices 2 (the infrared sensors 8 and the ultrasonic sensors 9) to detect the positions of users H. However, the device that detects the positions of users is not limited to the above. For example, it is possible to detect a user H in the detection area S by taking a picture of the detection area S using a camera capable of taking moving pictures and by processing the picture that the camera has taken. A user H may put on an electronic tag that stores information (height information) about the height of the user H and the like, thereby allowing the small screen display system 100 to communicate with the electronic tag of the user H to detect the position information (xy coordinates) of the electronic tag and acquire the height information (z coordinate). In particular, the above technique of using the camera or electronic tags is effective when the display device 1 is installed outdoors and the sensor devices 2 cannot be mounted on the ceiling.

Moreover, according to the present embodiment, the small screen display system 100 can be applied to various facilities. In particular, the display device 1 is preferably used as an advertisement display. For example, when a user H approaches a supersize display on the street, the small screen display system 100 may detect the position of the user H and display an advertisement image at the line-of-sight position of the user H. In this case, the small screen display system 100 is useful because an advertisement is displayed for the user when the user just approaches the supersize display even if the hands of the user H are occupied by bags and the like.

Moreover, the size of an image displayed on the supersize display may vary according to how far a user is apart from the supersize display. For example, when a user stays away from the supersize display, an advertisement image is displayed over the display screen of the supersize display; when the user comes closer to the supersize display, the same advertisement image is displayed on a small screen 7, because the user may not be able to see what is displayed when the user is too close to the supersize screen. Therefore, displaying the advertisement image on the small screen 7 allows the user to see the displayed image even when the user approaches the supersize screen.

Incidentally, according to the present embodiment, the small screen display system 100 controls the small screen 7 in such a way that when a user H moves away, the small screen 7 is deleted. Alternatively, the small screen 7 may be displayed so as to follow the line-of-sight position of the user H. In this case, when the above display device 1 is used as an advertisement display, a user H can watch an advertisement image as the user H passes by the display device 1.

The small screen display system 100 designed to display a small screen 7 that follows the line-of-sight position of the user H is suitable for amusement facilities. For example, for a shooter game in which a plurality of users play in front of the large screen 11, information necessary for the game is displayed at the line-of-sight positions so as to follow the line-of-sight positions of the users H. When a transmissive display is attached to a tank in an aquarium or the like, guide information may be displayed at the line-of-sight positions so as to follow the movement of the users H.

The above has described the embodiment of the present invention. However, the present invention is not limited to the above embodiment. Various changes and modifications may occur on the embodiment of the present invention without departing from the principles of the present invention. All such changes and modifications fall within the technical scope of the present invention.

1-15. (canceled)

16. A screen display system comprising:
a display means having an image display surface of a first size;
a position detection means for detecting a line-of-sight position of a user who exists in a predetermined area in front of the image display surface; and
a screen processing means for displaying on the image display surface a small screen of a second size that is smaller than the first size in accordance with the line-of-sight position of the user detected by the position detection means;
wherein,
the position detection means includes:
three-dimensional patterns concerning body shapes and postures of a plurality of persons;
a first detection means for making a determination as to whether a detected object is a person by comparing a detected shape with the three-dimensional patterns;
a second detection means for detecting a three-dimensional position of the head of a detected user when the detected object is a person; and
a correction means for calculating a line-of-sight position from the three-dimensional position of the head of the detected user in a predetermined way.

17. The screen display system according to claim 16, wherein
the screen processing means deletes the small screen that is displayed in accordance with the line of sight of the user when it is determined that the user detected by the position detection means moves.

18. The screen display system according to claim 16, wherein
the position detection means detects the respective line-of-sight positions of a plurality of users who exist in the predetermined area in front of the image display surface; and
the screen processing means displays the respective small screens of the second size in accordance with the respective line-of-sight positions of the plurality of the users detected by the position detection means.

19. The screen display system according to claim 16 claim 18, wherein
when respective the line-of-sight positions of the plurality of users detected by the position detection means are within a predetermined range, the screen processing means displays one common small screen of the second size based on the line-of-sight positions of the plurality of users.

20. The screen display system according to claim 19, wherein
the screen processing means displays the common small screen at an average position of the respective line-of-sight positions of the plurality of users.

21. The screen display system according to claim 19, wherein
the screen processing means displays the common small screen in accordance with the line-of-sight position of a first user detected by the position detection means among the plurality of the users.

22. The screen display system according to claim 19, wherein
when the position detection means determines that one of the plurality of users moves, the screen processing means displays the common small screen after moving the common small screen on the basis of the line-of-sight positions of remaining users.

23. The screen display system according to claim 22, wherein
when the number of the remaining users is two or more, the screen processing means displays the common small screen at an average position of the line-of-sight positions of the remaining users.

24. The screen display system according to claim 22, wherein
when the number of the remaining users is one, the screen processing means displays the common small screen in accordance with the line-of-sight position of the remaining user.

25. The screen display system according to claim 22 claim 19, wherein
when the respective line-of-sight positions of the plurality of users detected by the position detection means are within the predetermined range and differences in the height of line-of-sight position between the plurality of users are greater than or equal to a predetermined threshold, the screen processing means displays the respective small screens of the second size in accordance with the respective line-of-sight positions of the plurality of users.

26. The screen display system according to claim 22 claim 16, wherein
the screen processing means changes the second size in accordance with a distance between the line-of-sight position of the user detected by the position detection means and the image display surface.

27. The screen display system according to claim 16, wherein
the screen processing means displays a small screen of the second size that follows a change in the line-of-sight position of the user detected by the position detection means.

28. A screen display program that can be read by a computer that displays information on a display means having an image display surface of a first size, the screen display program causing the computer to execute:
a position detection step of detecting a line-of-sight position of a user who exists in a predetermined area in front of the image display surface; and
a screen processing step of displaying on the image display surface a small screen of a second size that is smaller than the first size in accordance with the line-of-sight position of the user detected by the position detection step;
wherein,
the computer includes:
three-dimensional patterns concerning body shapes and postures of a plurality of persons;
the position detection step comprises:
a first detection step of making a determination as to whether a detected object is a person by comparing a detected shape with the three-dimensional patterns;
a second detection step of detecting a three-dimensional position of the head of a detected user when the detected object is a person; and
a correction step of calculating a line-of-sight position from the three-dimensional position of the head of the detected user in a predetermined way.

29. The screen display program according to claim 28, wherein
the small screen of the second size is deleted by the screen processing step when it is determined that the user detected by the position detection step moves.
